(19) United States
(12) Patent Application Publication
(10) Pub. No.: US 2018/0121965 A1
(43) Pub. Date: May 3, 2018

(54) SUPPRESSING REDUNDANT PROMOTIONAL MESSAGING BASED UPON IDENTIFIED CUSTOMER INTERACTIONS

(71) Applicant: International Business Machines Corporation, Armonk, NY (US)

(72) Inventors: Jeremy A. Greenberger, Raleigh, NC (US); Dana L. Price, Surf City, NC (US)

(21) Appl. No.: 15/335,491

(22) Filed: Oct. 27, 2016

(51) Int. Cl. G06Q 30/02

(52) U.S. Cl. CPC G06Q 30/0272; G06Q 30/0267

(57) ABSTRACT

Embodiments of the present invention provide a method, system and computer program product for suppressing redundant promotional messaging based upon identified customer interactions. The method includes detecting a presence of a mobile device in a geographically confined venue and identifying a customer associated with the mobile device. The method also includes sensing a customer interaction between an agent of the venue and the customer and receiving from the agent information characterizing the customer interaction. The method yet further includes receiving a directive to transmit a promotional message to the customer, and determining if the promotional message is redundant to the information characterizing the customer interaction. Finally, the method includes responding to a determination that the promotional message is redundant to the information characterizing the customer interaction by suppressing the transmission of the promotional message, but otherwise transmitting to the customer the promotional message.

### BACKGROUND OF THE INVENTION

### Field of the Invention

The present invention relates to presence sensed customer interactions and more particularly to utilizing presence sensed customer interactions in suppressing promotional messaging.

### Description of the Related Art

In the retail environment, knowing customer behavior in store can be important in understanding how best to organize the structuring of aisles in the store and the shelving of goods in each aisle. Equally important is the knowledge of which products in the store are of greatest interest to customers and whether or not customers understand the nature and cost of the products sold in the store. Providing timely customer service to a customer in need in an aisle of a store can be the difference between a sold product and a product which remains on the shelf.

To assist in servicing customers in the retail environment, modern retail computing systems provide automated support for customer service representatives on the floor of the store and also direct inquiries to customer product support. The most simple of systems respond to customer directed inquiries at input devices positioned about the store with product information or by summoning in-person support by a customer service representative. More complex systems utilize sensor arrays disposed throughout the store to sense a presence of a shopper in proximity to a particular product or customer service agent. Other systems sense a presence of a mobile device associated with a particular customer so as to enjoy an understanding of customer movements and activities within the store.

In those systems in which a mobile device of an end user is sensed within the store, a multiplicity of customer engagement interactions become possible. In one scenario, as the mobile device is detected in proximity to a particular product, the system may push product information to the mobile device for the proximately positioned product. As well, a coupon or other promotional incentive may be provided to the customer through the mobile device. In another scenario, as the mobile device is detected in proximity to a customer service agent on the floor of the store, a notice may be pushed to the customer service agent providing information for use by the customer service agent in approaching the customer so as to support a possible sale of a product in the store.

### BRIEF SUMMARY OF THE INVENTION

Embodiments of the present invention address deficiencies of the art in respect to promotional messaging and provide a novel and non-obvious method, system and computer program product for suppressing redundant promotional messaging based upon identified customer interactions. In an embodiment of the invention, a method for suppressing redundant promotional messaging based upon identified customer interaction includes detecting, in a retail computing system, a presence of a mobile device in a geographically confined venue and identifying, by the retail computing system, a customer associated with the mobile device. The method also includes sensing in the retail computing system a customer interaction between an agent of the venue and the customer and receiving in the retail computing system from the agent information characterizing the customer interaction. The method yet further includes receiving a directive in the retail computing system to transmit a promotional message to the customer, determining if the promotional message is redundant to the information characterizing the customer interaction. Finally, the method includes responding to a determination that the promotional message is redundant to the information characterizing the customer interaction by suppressing the transmission of the promotional message, but otherwise transmitting to the customer the promotional message.

In one aspect of the embodiment, the customer interaction is sensed by sensing a proximity of the mobile device to a mobile device of the agent for a threshold duration of time. Alternatively, the customer interaction is sensed by a manual indication of the interaction by the agent. In another aspect of the embodiment, the information characterizing the customer interaction is received from a mobile device of the agent in response to a prompt presented to the agent after sensing a proximity of the agent to the mobile device for a threshold duration of time. In yet another aspect of the embodiment, the determination that the promotional message is redundant to the information characterizing the customer interaction is based upon the information characterizing the customer interaction including a promotional offer presented to the customer during the interaction that is the subject of the promotional message.

In another embodiment of the invention, a retail data processing system includes a host computing system with one or more computers, each with memory and at least one processor. The system also includes a redundant promotional messaging suppression module. The module includes program code enabled upon execution in the memory of the host computing system to detect a presence of a mobile device in a geographically confined venue and identify a customer associated with the mobile device, to sense a customer interaction between an agent of the venue and the customer and receiving in the retail computing system from the agent information characterizing the customer interaction, to receive a directive to transmit a promotional message to the customer, to determine if the promotional message is redundant to the information characterizing the customer interaction and to respond to a determination that the promotional message is redundant to the information characterizing the customer interaction by suppressing the transmission of the promotional message, but otherwise transmitting to the customer the promotional message.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and, together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for suppressing redundant promotional messaging based upon identified customer interactions;

FIG. 2 is a schematic illustration of a data processing system configured for suppressing redundant promotional messaging based upon identified customer interactions; and,

FIG. 3 is a flow chart illustrating a process for suppressing redundant promotional messaging based upon identified customer interactions.

### DETAILED DESCRIPTION OF THE INVENTION

Embodiments of the invention provide for suppressing redundant promotional messaging based upon identified customer interactions. In accordance with an embodiment of the invention, a retail computing system detects a mobile device within a store and associates the detected mobile device with a customer of the store. Subsequently, the retail computing system senses a customer interaction by an employee of the store in connection with the detected mobile device and the retail computing system receives information pertaining to the customer interaction from a different computing device of the employee. The retail computing system then stores the information in association with the customer interaction. Later, when coordinating a transmission of promotional messaging to the customer, a determination is made if the promotional messaging is redundant to information associated with the stored information from the customer interaction. If so, the retail computing system suppresses the transmission of the promotional messaging to the customer. But otherwise, the retail computing system transmits the promotional messaging to the customer. Consequently, server side computing overhead is conserved because the total number of promotional messages sent by the server is reduced. As well, the amount of memory and reception overhead utilized on the client device is reduced since the number of promotional messages received by the customers device is reduced.

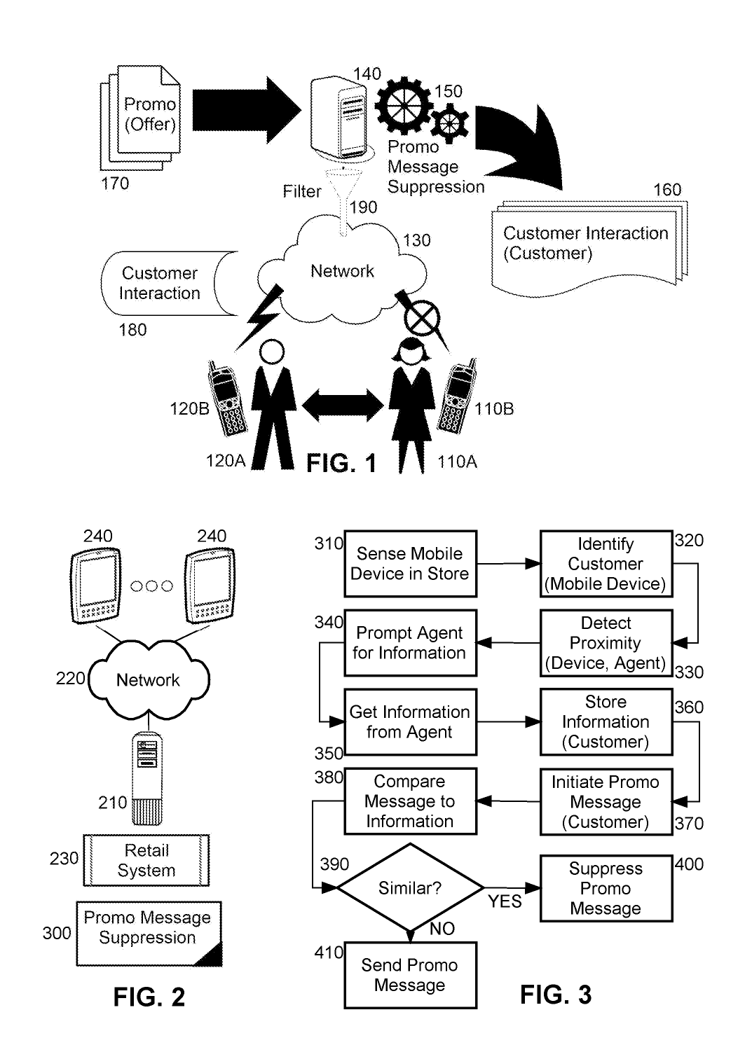

In further illustration, FIG. 1 pictorially shows a process for suppressing redundant promotional messaging based upon identified customer interactions. As shown in FIG. 1, a retail system 140 detects a mobile device 110B of a customer 110A within a retail space such as a geographically confined space such as a brick and mortar retail store, or a virtually confined space such as a virtual store in a virtual reality environment with avatar representations of individuals present in the virtual store. The retail system 140 additionally senses a customer interaction 180 between an agent 120A of the retail store and the customer 110A. For instance, the retail system 140 detects a proximity of the mobile device 110B of the customer 110A to a mobile device 120B of the agent 120A. Thereafter, the retail system 140 receives from a mobile device 120B of the agent 120A over network 130 customer interaction information 160, such as one or more promotional offers presented to the customer 110A.

Promotional message suppression logic 150 then stores the customer interaction information 160 in association with the customer 110A. Subsequently, in response to a directive in the retail system 140 to transmit a promotional message 170 to different customers including the customer 110A, the promotional suppression logic 150 applies a filter 190 to the transmission of the promotional message 170 to suppress transmission of the promotional message 170 to the customer 110A when a subject of the promotional message 170 compares in content to that of the customer interaction information 160 for the customer 110A.

The process described in connection with FIG. 1 may be implemented in a retail data processing system. In further illustration, FIG. 2 schematically illustrates a data processing system configured for suppressing redundant promotional messaging based upon identified customer interactions. The system includes a host computing system 210 that includes one or more computers, each with memory and at least one processor. The host computing system 210 supports the operation of a retail system adapted to perform presence sensing retail operations such as detecting within a store a presence of different mobile devices 240 of different customers and to receive from over a computer communications network 220, customer interaction feed back from others of the mobile devices 240 of agents of the store.

Of note, a promotional message suppression module 300 is coupled to the retail system 230 and executes in the memory of the host computing system 210. The promotional message suppression module 300 includes program code that when executed in the memory of the host computing system, is enabled to sense a customer interaction between a customer and agent within the store. For example, the customer interaction may be sense manually through input provided by the agent through one of the mobile devices 240 associated with the agent, or the customer interaction may be sensed based upon a measured proximity by the retail system 230 of the mobile device 240 of the agent and the mobile device 240 of the customer for a threshold duration of time.

The program code of the promotional message suppression module 300 is further enabled upon execution in the memory of the host computing system 210 to respond to a sensed customer interaction by receiving from a mobile device 240 of the agent information characterizing the customer interaction. As well, the program code of the promotional message suppression module 300 is enabled to store the information characterizing the customer interaction in association with the customer. Thereafter, when a transmission of a promotional message is requested in the retail system 230, the promotional message suppression module 300 compares an identity of a target customer to different, previously stored characterizations of customer interactions in order to determine if a prior customer interaction exists for a target customer. If so, it is determined further if the customer interaction pertains to the promotional message and if so, the promotional message suppression module 300 suppresses the transmission of the promotional message.

In yet further illustration of the operation of the promotional message suppression module, FIG. 3 is a flow chart illustrating a process for suppressing redundant promotional messaging based upon identified customer interactions. Beginning in block 310, a mobile device is sensed in the store. In block 320, a customer corresponding to the mobile device is identified and in block 330, the mobile device of the customer is determined to be proximate to a mobile device of an agent in the store. In block 340, the agent is then prompted to provide information pertaining to the customer and in block 350, information pertaining to a perceived customer interaction is provided by the agent and in block 360 the information is stored in connection with the customer.

In block 370, transmission of a promotional message to the customer is initiated and in block 380, the message is compared to the stored customer interaction data for the customer. In decision block 390, if the customer interaction data is deemed similar to the content of the promotional message, then in block 400 the transmission of the promotional message to the customer is suppressed. Otherwise, in block 410 the promotional message is transmitted to the customer.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1. A method for suppressing redundant promotional messaging based upon identified customer interaction, the method comprising:
detecting in a retail computing system, a presence of a mobile device in a retail venue and identifying by the retail computing system a customer associated with the mobile device;
sensing in the retail computing system a customer interaction between an agent of the venue and the customer by detecting a proximity of the mobile device of the customer to a mobile device of the agent, and receiving in the retail computing system from the agent information characterizing the customer interaction including one or more promotional offers presented to the customer;
receiving a directive in the retail computing system to transmit a promotional message to the customer, and determining if the promotional message is redundant to the information characterizing the customer interaction, namely the one or more promotional offers presented to the customer; and,
responsive to a determination that the promotional message is redundant to the information characterizing the customer interaction, suppressing the transmission of the promotional message, but otherwise transmitting to the customer the promotional message.

2. The method of claim 1, wherein the customer interaction is sensed by sensing a proximity of the mobile device to a mobile device of the agent for a threshold duration of time.

3. The method of claim 1, wherein the customer interaction is sensed by a manual indication of the interaction by the agent.

4. The method of claim 1, wherein the information characterizing the customer interaction is received from a mobile device of the agent in response to a prompt presented to the agent after sensing a proximity of the agent to the mobile device for a threshold duration of time.

5. The method of claim 1, wherein the determination that the promotional message is redundant to the information characterizing the customer interaction is based upon the information characterizing the customer interaction including a promotional offer presented to the customer during the interaction that is the subject of the promotional message.

6. A retail data processing system comprising:
a host computing system comprising one or more computers, each with memory and at least one processor; and,
a redundant promotional messaging suppression module comprising program code enabled upon execution in the memory of the host computing system to detect a presence of a mobile device in a retail venue and identify a customer associated with the mobile device, to sense a customer interaction between an agent of the venue and the customer and receiving in the retail computing system from the agent information characterizing the customer interaction, to receive a directive to transmit a promotional message to the customer, and to determine if the promotional message is redundant to the information characterizing the customer interaction and to respond to a determination that the promotional message is redundant to the information characterizing the customer interaction by suppressing the transmission of the promotional message, but otherwise transmitting to the customer the promotional message.

7. The system of claim 6, wherein the customer interaction is sensed by sensing a proximity of the mobile device to a mobile device of the agent for a threshold duration of time.

8. The system of claim 6, wherein the customer interaction is sensed by a manual indication of the interaction by the agent.

9. The system of claim 6, wherein the information characterizing the customer interaction is received from a mobile device of the agent in response to a prompt presented to the agent after sensing a proximity of the agent to the mobile device for a threshold duration of time.

10. The system of claim 6, wherein the determination that the promotional message is redundant to the information characterizing the customer interaction is based upon the information characterizing the customer interaction including a promotional offer presented to the customer during the interaction that is the subject of the promotional message.

11. A computer program product for suppressing redundant promotional messaging based upon identified customer interaction, the computer program product comprising a non-transitory computer readable storage medium having program instructions embodied therewith, the program instructions executable by a device to cause the device to perform a method comprising:
detecting in a retail computing system, a presence of a mobile device in a retail venue and identifying by the retail computing system a customer associated with the mobile device;
sensing in the retail computing system a customer interaction between an agent of the venue and the customer by detecting a proximity of the mobile device of the customer to a mobile device of the agent, and receiving in the retail computing system from the agent information characterizing the customer interaction including one or more promotional offers presented to the customer;
receiving a directive in the retail computing system to transmit a promotional message to the customer, and determining if the promotional message is redundant to the information characterizing the customer interaction, namely the one or more promotional offers presented to the customer; and,
responsive to a determination that the promotional message is redundant to the information characterizing the customer interaction, suppressing the transmission of the promotional message, but otherwise transmitting to the customer the promotional message.

12. The computer program product of claim 11, wherein the customer interaction is sensed by sensing a proximity of the mobile device to a mobile device of the agent for a threshold duration of time.

13. The computer program product of claim 11, wherein the customer interaction is sensed by a manual indication of the interaction by the agent.

14. The computer program product of claim 11, wherein the information characterizing the customer interaction is received from a mobile device of the agent in response to a prompt presented to the agent after sensing a proximity of the agent to the mobile device for a threshold duration of time.

15. The computer program product of claim 11, wherein the determination that the promotional message is redundant to the information characterizing the customer interaction is based upon the information characterizing the customer interaction including a promotional offer presented to the customer during the interaction that is the subject of the promotional message.
